(19) United States
(12) Patent Application Publication
(10) Pub. No.: US 2005/0073826 A1
(43) Pub. Date: Apr. 7, 2005

(54) Light guide plate with multiple visible regions

(76) Inventor: Heng Sheng Kuo, Taipei (TW)

Correspondence Address: HENG SHENG KUO, P.O. BOX 26-757, TAIPEI, TW

(21) Appl. No.: 10/681,810

(22) Filed: Oct. 6, 2003

(51) Int. Cl. F21V 8/00

(52) U.S. Cl. 362/26; 362/31; 362/85

(57) ABSTRACT

A light guide plate with multiple visible regions, is adopted for a backlight module of a display device. The backlight module has at least one kind of lighting member. The light guide plate has a thin plate and a plurality of holes formed in predetermined positions of the thin plate. Each hole guides the light emitted from the lighting member towards an outside of the thin plate to meet requirements for lighting in predetermined positions and conserving power.

### BACKGROUND OF THE INVENTION

1. Field of the Invention

The present invention relates to a light guide plate with multiple visible regions. More particularly, the present invention relates to a thin light guide plate with a plurality of lighting areas.

2. Background of the Invention

The conventional light guide plates spread light evenly by various densities and various sizes spots disposed thereon applied in various information and telecommunication products. Technologies of the conventional light guide plates include dot patterns, textured finishing, etching, stamping, V-cuts and the like to increase the luminance, uniformity, and decrease the optical losses thereof.

However, with tendencies of electronic products to be lightweight, power conserving, cheap, and having multiple functions, the conventional light guide plate must be increasingly thinner and is broadly applied in various fields. Moreover, the conventional light guide plate has to be processed more than the technologies mentioned above. Referring to FIG. 1, the conventional cell phone 1a includes a body 10a, a cover 11a corresponding to the body 10a, and a plurality of LEDs (Light Emitting Diode) 12a disposed on the body 10a. The cover 11a has a plurality of operating keys 111a arranged thereon, the LEDs 12a emit light transmitted through the cover 11a to allow easy recognition and manipulation of the keys 111a by users. As electronic products, such as the phone, the keyboard, and the notebook, develop with an enlarged display region, the LEDs 12a must also be increased and disobey the tendencies mentioned above.

In the conventional cell phone 1a mentioned above, LEDs 12a are arranged to light the keys 11a for recognition; as the display region increases, in applications such as phones, keyboards, notebooks, and so on, the LEDs 12a consequently increase in number. This does not follow the trend towards lightweight, small and power conserving devices.

### SUMMARY OF INVENTION

The object of the invention is therefore to specify a light guide plate with multiple visible regions to emit light from a plurality of separate and predetermined display regions.

Another object of the invention is therefore to specify a light guide plate with multiple visible regions that provides a light weight, thin, light-efficient, cheap and power conserving device.

According to the invention, this object is achieved by a light guide plate with multiple visible regions, adopted for a backlight module of a display device, in which the backlight module has at least one kind of lighting member. The light guide plate includes a thin plate and a plurality of holes formed on predetermined positions of the thin plate. Each hole guides the light emitted from the lighting member towards an outside of the thin plate.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a conventional cell phone;

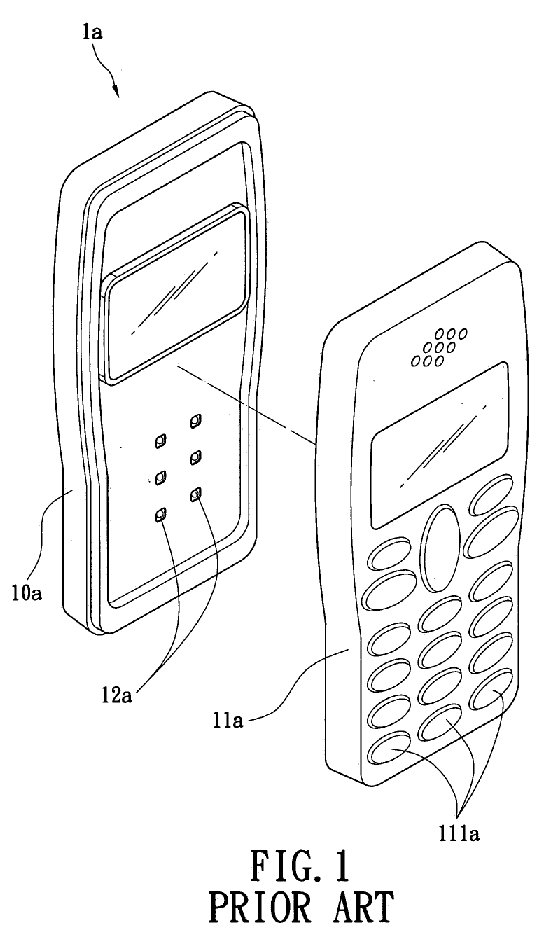

FIG. 2 is a perspective view of a first embodiment according to the present invention;

FIG. 3 is a perspective view of a second embodiment according to the present invention, and

FIG. 4 is a perspective view of an application of the present invention.

### DETAILED DESCRIPTION OF THE EMBODIMENTS

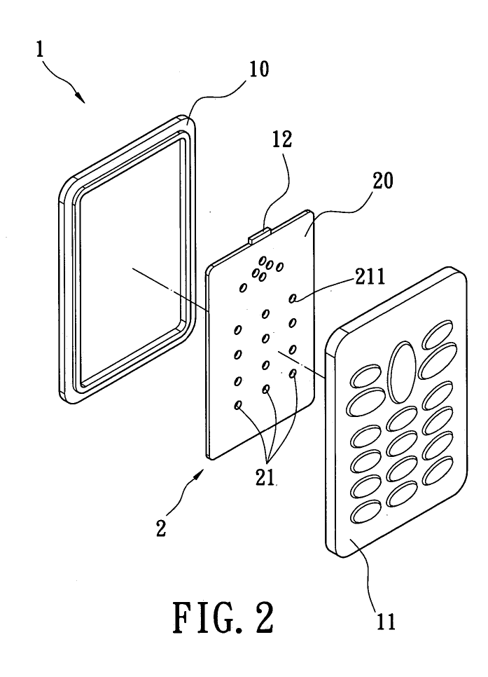

Referring to FIG. 2, the present invention provides a light guide plate 2 with multiple visible regions applied in a backlight module of a display device 1, in which the backlight module has at least one kind of lighting member 12 for emitting light. The display device 1 includes a body 10, a cover 11 relating to the body 10. The light guide plate 2 has a thin plate 20, which is less than 2 mm, and a plurality of holes 21 formed in predetermined positions of the thin plate 20 for guiding the light towards an outside of the thin plate 20.

A conventional light guide plate avoids having the holes 21 and the like for the reason that the holes 21 cannot preserve the light and the optical loss will rise.

However, the present invention provides the light guide plate 2 to meet practical requirements that the light can transmit and be emitted from a predetermine position of the light guide plate 2 and users can recognize where the light is emitted from, because the thin plate 20 is designed to have a total inner reflection effect. The light emitted from the lighting member 12 transmits within the thin plate 20 and is not released, so the thin plate 20 looks dark. If there is a need for recognition on the thin plate 20, the thin plate 20 can be formed with a plurality of the holes 21, and the light is released through the holes 21 by the reflection or the refraction. Accordingly, areas where the holes are formed are lit and visible.

The thin plate 20 less than 2 mm is light weight, the holes 21 are arranged to be separate display regions of the thin plate 20, and only one lighting member 12 is sufficient for the thin plate 20. The light guide plate 2 thus saves the lighting member 12, and is lit in predetermined regions thereon.

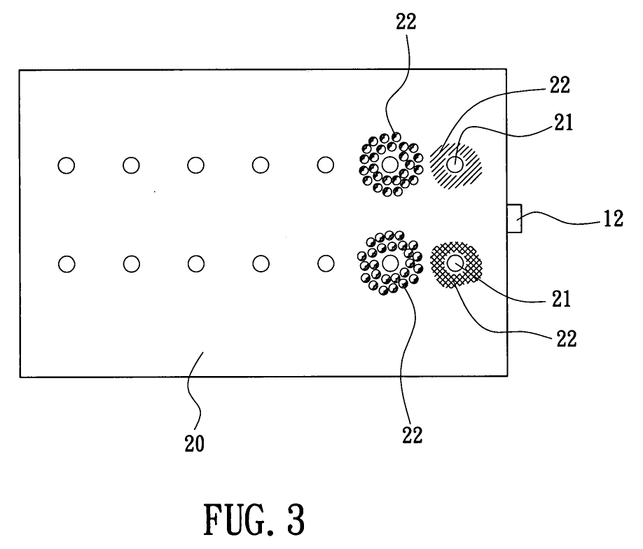

The light is emitted towards the holes 21 with various incident angles, and out from the thin plate 20 by the reflection or the refraction; the light along wall 211 of the hole 21 is brightest. At least one of the holes 21 penetrates through the thin plate 20 from one of an upper surface and a lower surface thereof to the other, or concaves a predetermined depth, which is less than a thickness of the thin plate 20, of the thin plate 20 from one of an upper surface and a lower surface. With respect to FIG. 3, the light guide plate 2 further includes at least one pattern 22 arranged around a periphery of at least one of the holes 21 for increasing the brightness, in which the pattern 22 is a convex, a concave, or a textured pattern.

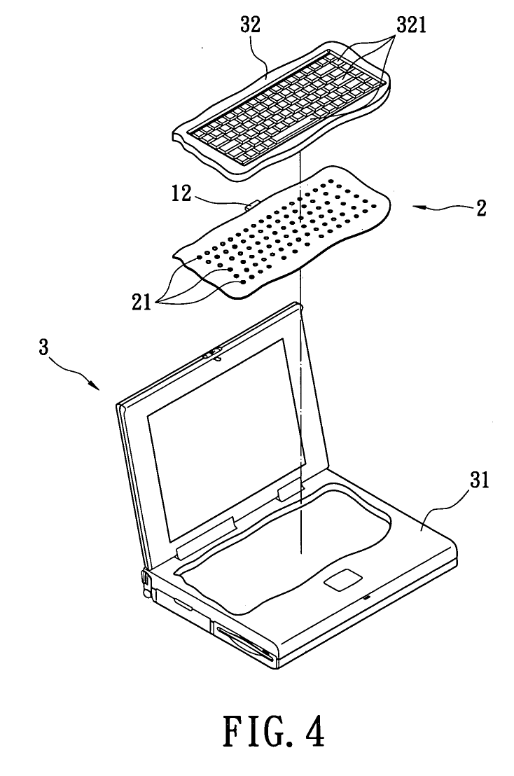

Referring to FIG. 4, the light guide plate 2 is adopted for a notebook 3, and at least one of the holes 21 is formed in a base 31 thereof and relating to a keypress 321 of a panel 32 thereof. For example, the space keypress of notebook 3 and the keypress 321 can be easily operated and recognized. The light guide plate 2 can applied in not only a notebook, but also a cell phone, a telephone, a keyboard of a computer, a PDA (Palm Digital Assistant), an IA system (Information Application system) and the like.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A light guide plate with multiple visible regions, adopted for a backlight module of a display device, wherein the backlight module includes at least one kind of lighting member for emitting light, comprising:
a thin plate; and
a plurality of holes formed in predetermined positions of the thin plate for respectively guiding the light towards an outside of the thin plate.

2. The light guide plate as claim 1 claimed, wherein the lighting member is disposed on one edge of the thin plate, wherein the thin plate includes a front edge, a rear edge, and two side edges.

3. The light guide plate as claim 2 claimed, wherein the lighting member is an LED.

4. The light guide plate as claim 1 claimed, wherein the light guide plate has a thickness less than 2 mm.

5. The light guide plate as claim 1 claimed, wherein the display device has a cover including a plurality of displaying portions formed thereon and respectively relating to the predetermined positions of the holes.

6. The light guide plate as claim 5 claimed, wherein each display portion covers at least one of the holes.

7. The light guide plate as claim 5 claimed, wherein each display portion has a printing formed thereon with predetermined meanings, such as a sign, a word, or a design.

8. The light guide plate as claim 7 claimed, wherein each displaying portion has a keypress relating to the pattern for operation by users.

9. The light guide plate as claim 1 claimed, wherein at least one of the holes penetrates through the thin plate from one of an upper surface and a lower surface thereof to another.

10. The light guide plate as claim 1 claimed, wherein at least one of the holes is concave to a predetermined depth, wherein the predetermined depth is less than a thickness of the thin plate, of the thin plate from one of an upper surface and a lower surface.

11. The light guide plate as claim 1 claimed, further including at least one pattern arranged around a periphery of at least one of the holes for increasing the brightness.

12. The light guide plate as claim 11 claimed, wherein the pattern is a convex, a concave, or a textured pattern.
